(19) United States
(12) Patent Application Publication
(10) Pub. No.: US 2019/0121048 A1
(43) Pub. Date: Apr. 25, 2019

(54) OPTICAL FIBER LAYING METHOD BY USING ARCHIMEDES SPIRAL IN OPTICAL FREQUENCY DOMAIN REFLECTION

(71) Applicant: Tianjin University, Tianjin (CN)

(72) Inventors: Tiegen LIU, Tianjin (CN); Zhenyang DING, Tianjin (CN); Di YANG, Tianjin (CN); Kun LIU, Tianjin (CN); Junfeng JIANG, Tianjin (CN); Zhexi XU, Tianjin (CN)

(73) Assignee: Tianjin University, Tianjin (CN)

(21) Appl. No.: 15/565,682

(22) PCT Filed: Oct. 26, 2016
(86) PCT No.: PCT/CN2016/103520

§ 371 Date: Oct. 11, 2017

(30) Foreign Application Priority Data
Jun. 24, 2016 (CN) 201610487752.4

(51) Int. Cl. G02B 6/44; G02B 27/09; F21V 8/00

(52) U.S. Cl. CPC G02B 6/4463; G02B 6/0006; G02B 27/0977

(57) ABSTRACT

The present invention discloses an optical fiber laying method by using Archimedes spiral in optical frequency domain reflection, wherein the optical fiber laying method comprises the following steps: performing two measurements continuously via a two-dimensional strain sensing device, and performing cross-correlation operation on the two one-dimensional information of the local distance domain, and obtaining the strain variation of the one-dimensional information corresponding to the two measurements from the obtained cross-correlation information; deriving the two-dimensional angle information and curvature radius information of the plane to be measured corresponding to one-dimensional information in the local distance domain based on Archimedes spiral formula; deriving the position coordinates corresponding to the two-dimensional plane based on the curvature radius information and two-dimensional angle information; corresponding the strain variation of the one-dimensional information to the position coordinates corresponding to the two-dimensional plane to obtain the two-dimensional strain information. By using one fiber to measure the two-dimensional strain, the present invention realizes strain measurement in the transverse direction, the longitudinal direction and the synthetic direction thereof, solves the existing problem of insufficient sensitivity in multi-directional sensing, thus satisfies different requirements in the practical applications.

### TECHNICAL FIELD

The present invention relates to a distributed optical fiber sensing apparatus, and in particular to an optical fiber laying method by using Archimedes spiral in optical frequency domain reflection.

### BACKGROUND OF THE PRESENT INVENTION

Distributed strain sensing devices with high precision and high spatial resolution are widely used in the livelihoods and national defense security fields, such as structural health monitoring of aircraft, spacecraft, ships, defense equipments, industrial equipments, bridge culverts and other key parts, and a two-dimensional distributed strain sensing can be achieved by using optical fiber laying method, such as parallel laying method, in optical frequency domain reflection. However, strains may be generated in all directions in the two-dimensional space practically, the normal fiber laying method can only reflect the strain in a single direction. Therefore, it is required to adopt a new method to reflect the two-dimensional strain in all directions.

### SUMMARY OF THE PRESENT INVENTION

The present invention provides an optical fiber laying method by using Archimedes spiral in optical frequency domain reflection, which overcomes the problems of insufficient sensitivity in multi-directional sensing, and satisfies the requirement of multi-directional two-dimensional strain sensing. The details of the present invention are as follows:

An optical fiber laying method by using Archimedes spiral in optical frequency domain reflection (hereinafter referred to as OFDR) is provided, the method of the present invention includes the following steps:

performing two measurements continuously via a two-dimensional strain sensing device, and performing cross-correlation operation on the two one-dimensional information in the local distance domain, and obtaining the strain variation of the one-dimensional information corresponding to the two measurements from the obtained cross-correlation information;
deriving the two-dimensional angle information and curvature radius information of a plane to be measured corresponding to one-dimensional information in the local distance domain based on Archimedes spiral formula;
deriving the position coordinates corresponding to the two-dimensional plane based on the curvature radius information and two-dimensional angle information; and
corresponding the strain variation of the one-dimensional information to the position coordinates corresponding to the two-dimensional plane to obtain the two-dimensional strain information.

The steps of acquiring one-dimensional information in the local distance domain are as follows:

forming a beat frequency interference signal in the two-dimensional strain sensing device by Rayleigh backscattering, and performing fast Fourier transform on the beat frequency interference signal respectively; and
transforming the optical frequency information to the distance domain information corresponding to the respective positions, and selecting the respective positions of the distance domain information through a moving window with certain width successively to obtain the one-dimensional information in the local distance domain.

The optical fiber laying method adopts Archimedes spiral in OFDR, which uses a fiber to measure the strain of the two-dimensional space.

The end of the fiber does not require any additional apparatus.

The formulae of the step of “corresponding the strain variation of the one-dimensional information to the position coordinates corresponding to the two-dimensional plane to obtain the two-dimensional strain information” are:

$$x = a * cos ( \sqrt{\frac{2 L}{a}} )$$

$$y = a * sin ( \sqrt{\frac{2 L}{a}} )$$

Wherein, the parameter a>0, and L is curve length.

The technical solutions of the present invention have the following beneficial effects: the present invention realizes distributed strain measurement based on the Rayleigh backscattering frequency shifting in the OFDR; applies Archimedes spiral on the plane to be measured for fiber laying, and measures the two-dimensional strain so as to satisfy the requirement of multi-directional two-dimensional strain sensing; that is to say, the present invention realizes strain measurement in the transverse direction, the longitudinal direction and the synthetic direction thereof, solves the existing problem of insufficient sensitivity in multi-directional sensing, thus satisfies different requirements in the practical applications.

### BRIEF DESCRIPTION OF THE DRAWINGS

FIG. 1 is a flow chart of the optical fiber laying method by using Archimedes spiral in OFDR;

FIG. 2 is a flow chart of solving the two-dimensional strain information via the formula of Archimedes spiral, according to the one-dimensional strain distance information;

FIG. 3 is a schematic view of the two-dimensional strain sensing device according to the method of the present invention;

FIG. 4 is a schematic view of the optical fiber laying method of the two-dimensional strain sensing device;

FIG. 5 is the experimental rendering of the present invention;

in which:
1: tunable laser;
4: 1:99 beam splitter;
11: computer;
24: clock triggering system based on auxiliary interferometer;
25: main interferometer;
2: detector;
5: first 50:50 coupler;
6: clock shaping circuit module;
7: delay fiber;
8: first Faraday mirror;
9: second Faraday mirror;
10: isolator; 3:50:50 beam splitter;
12: polarization controller;
13: circulator;
14: second 50:50 coupler;
15: two-dimensional strain sensing fiber;
16: first polarization beam splitter;
17: second polarization beam splitter;
18: first balanced detector;
19: second balanced detector;
20: acquisition device;
21: GPIB control module;
22: reference arm;
23: test arm;
151: fiber;
152: plane to be measured.

### DETAILED DESCRIPTION OF THE PRESENT INVENTION

In order to make the objective, technical scheme and advantages of the present invention more clear, the present invention will be further described below.

### Embodiment 1

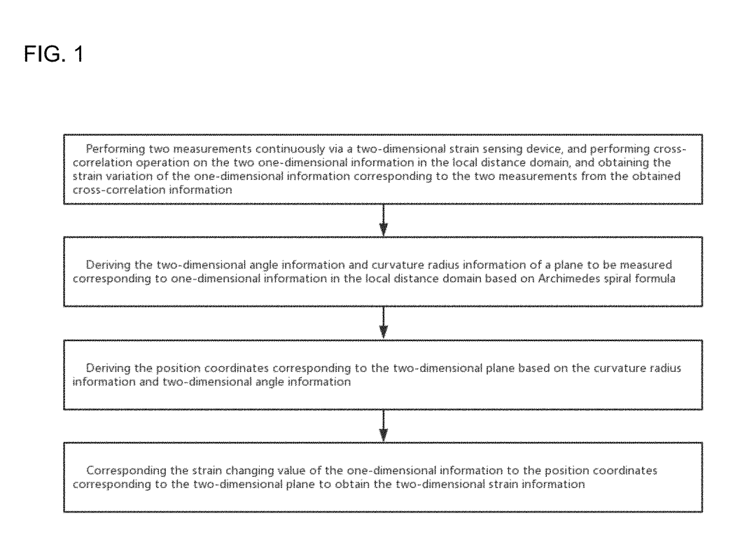

As shown in FIG. 1, the embodiment provides an optical fiber laying method by using Archimedes spiral in OFDR, the method includes the following steps:

101: performing two measurements continuously via two-dimensional strain sensing device, and performing cross-correlation operation on the two one-dimensional information in the local distance domain, and obtaining the strain variation of the one-dimensional information corresponding to the two measurements from the obtained cross-correlation information;

102: deriving the two-dimensional angle information and curvature radius information of a plane to be measured corresponding to one-dimensional information in the local distance domain based on Archimedes spiral formula;

103: deriving the position coordinates corresponding to the two-dimensional plane based on the curvature radius information and two-dimensional angle information; and

104: corresponding the strain variation of the one-dimensional information to the position coordinates corresponding to the two-dimensional plane to obtain the two-dimensional strain information.

Wherein, the detailed steps of acquiring one-dimensional information in the local distance domain in Step 101 are:

forming a beat frequency interference signal in the two-dimensional strain sensing device by Rayleigh backscattering, and performing fast Fourier transform on the beat frequency interference signal respectively; and transforming the optical frequency information to the distance domain information corresponding to the respective positions, and then selecting the respective positions of the distance domain information through a moving window with certain width successively to obtain the one-dimensional information in the local distance domain.

Wherein, the optical fiber laying method adopts Archimedes spiral in OFDR, which uses a fiber to measure the strain of the two-dimensional space.

Furthermore, the end of the fiber does not require any additional apparatus, which simplifies the operation process.

In conclusion, the embodiment of the present invention performs distributed strain measurement by fiber Rayleigh backscattering frequency shifting in OFDR, applies Archimedes spiral on the plane to be measured for fiber laying, and measures the two-dimensional strain so as to satisfy the requirement of multi-directional two-dimensional strain sensing.

### Embodiment 2

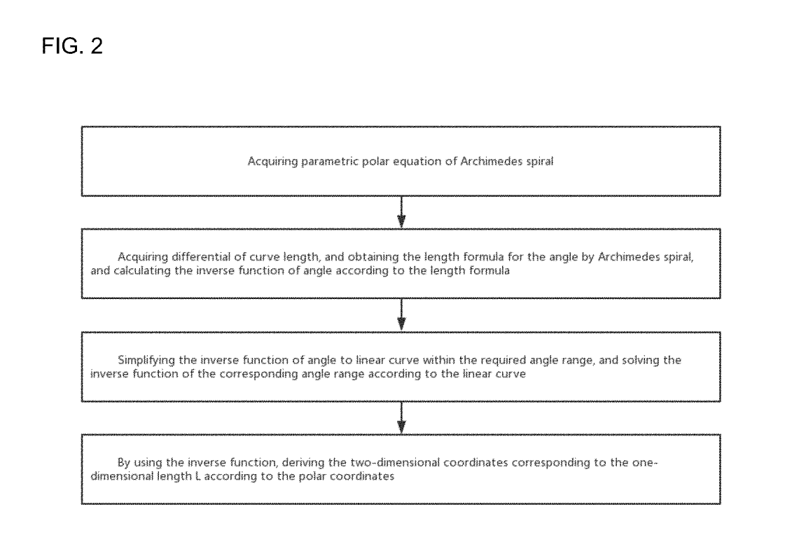

The technical scheme of embodiment 1 will be further described with reference to FIG. 1, FIG. 2 and specific calculation formulae. The measurement and calculation of parameters involved in the optical fiber laying method are achieved by a two-dimensional strain sensing device, the details are as follows:

201: forming a beat frequency interference signal in the two-dimensional strain sensing device by Rayleigh backscattering, and performing fast Fourier transform on the beat frequency interference signal respectively, and then transforming the optical frequency information to the distance domain information corresponding to the respective positions, and then selecting the respective positions of the distance domain information through a moving window with certain width successively to obtain the one-dimensional information in the local distance domain;

202: performing two measurements continuously via two-dimensional strain sensing device, and performing cross-correlation operation on the two one-dimensional information of the local distance domain, and obtaining the strain variation of the one-dimensional information corresponding to the two measurements through the obtained cross-correlation information;

wherein, since this step is known to people skilled in the art, the detailed operation process will not be further described in the embodiment.

203: deriving the two-dimensional angle information and curvature radius information of the plane to be measured corresponding to the one-dimensional information in the local distance domain based on the Archimedes spiral formula;

204: deriving the position coordinates corresponding to the two-dimensional plane based on the curvature radius information and two-dimensional angle information; and

205: corresponding the strain variation of the one-dimensional information to the position coordinates corresponding to the two-dimensional plane to obtain the two-dimensional strain information.

The calculations in Step 203 to Step 205 will be further described with reference to the following formulae:

(1) Acquiring parametric polar equation of Archimedes spiral;

Defined by Archimedes spiral, the polar coordinates of Archimedes spiral is r=a*θ, (a>0), expressed by parametric equation, the polar coordinates of Archimedes spiral is x=r*cos θ, y=r*sin θ; where, r is polar radius, θ is polar angle.

(2) Acquiring differential of curve length, and obtaining the length formula for the angle by Archimedes spiral, and calculating the inverse function of angle according to the length formula;

The differential of curve length by the parameter equation is: dl=\sqrt{x²+y²}dθ.

The curve length function L(φ) is to be obtained by integrating the length differential dl at 0 to φ; wherein, φ is the spiraling total angle formed by the fiber on the plane to be measured.

According to integration derivation, the length formula for the angle by Archimedes spiral is:

$$L ( ϕ ) = \frac{a}{2} ln ( ϕ + \sqrt{1 + {ϕ}^{2}} ) + \frac{a ϕ}{2} \sqrt{1 + {ϕ}^{2}}$$

And inverse function φ(L) of angle φ can be calculated according to the length formula.

(3) Simplifying the inverse function of angle to linear curve within the required angle range, and solving the inverse function of the corresponding angle range according to the linear curve;

Since the above function equation is a transcendental function, the exact analytic solution cannot be obtained, thus the equation is simplified to linear curve Lₒ(φ) according to L(φ) within the required angle range, and then the inverse function φₒ(L) of the corresponding angle range is solved by the linear equation.

In practical, due to the required winding number of Archimedes spiral is not much, the angle of φ may be within the range from 0 to 100a, and φ² is much larger than 1 in most ranges, thus the formula L(φ) may simplify to:

$$L ( ϕ ) = \frac{a}{2} ln ( 2 ϕ ) + \frac{a {ϕ}^{2}}{2}$$

Furthermore, within the angle range, the growth and value of

$$\frac{a {ϕ}^{2}}{2}$$

are much larger than

$$\frac{a}{2} ln ( 2 ϕ ) ,$$

thus L(φ) may simplify to the linear formula Lₒ(φ) as:

$${L}_{0} ( ϕ ) = \frac{a {ϕ}^{2}}{2}$$

(4) By using the inverse function, deriving the two-dimensional coordinates corresponding to the one-dimensional length L according to the polar coordinates.

By the inverse function φₒ(L), the two-dimensional coordinates x, y corresponding to the one-dimensional length L according to the polar coordinates can be derived as:

$$y = a * sin ( \sqrt{\frac{2 L}{a}} )$$

$$y = a * sin ( \sqrt{\frac{2 L}{a}} )$$

In conclusion, the embodiment of the present invention performs distributed strain measurement by single mode fiber Rayleigh backscattering frequency shifting in OFDR, applies Archimedes spiral on the plane to be measured for fiber laying, and measures the two-dimensional strain so as to satisfy the requirement of multi-directional two-dimensional strain sensing.

### Embodiment 3

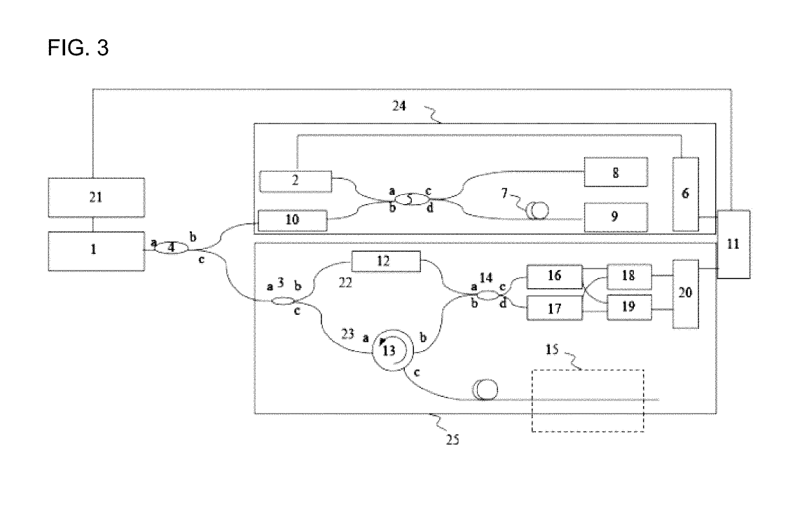

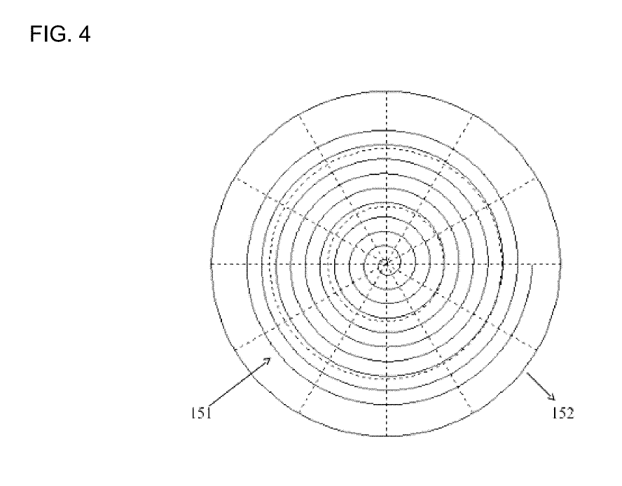

The two-dimensional strain sensing device of embodiment 1, 2 will be further described with reference to FIG. 3 and FIG. 4, the details are as follows:

As shown in FIG. 3, the two-dimensional strain sensing device comprises: a tunable laser 1; a 1:99 beam splitter 4, a computer 11, a GPIB control module 21, a clock triggering system based on auxiliary interferometer 24, and a main interferometer 25.

Wherein, the clock triggering system based on auxiliary interferometer 24 comprises a detector 2, a first 50:50 coupler 5, a clock shaping circuit module 6, a delay fiber 7, a first Faraday mirror 8, a second Faraday mirror 9 and an isolator 10. The clock triggering system based on auxiliary interferometer 24 achieves equal interval optical frequency sampling, and aims at inhibiting the non-linear scanning of optical source.

The main interferometer 25 comprises: a 50:50 beam splitter 3, a polarization controller 12, a circulator 13, a second 50:50 coupler 14, a two-dimensional strain sensing fiber 15, a first polarization beam splitter 16, a second polarization beam splitter 17, a first balanced detector 18, a second balanced detector 19, an acquisition device 20, a reference arm 22 and a test arm 23. The main interferometer 25, as the core of optical frequency domain reflector, is the improved Mach-Zehnder interferometer.

The input end of the GPIB control module 21 is communicated with the computer 11; the output end of the GPIB control module 21 is communicated with the tunable laser 1; the tunable laser 1 is communicated with the port a of the 1:99 beam splitter 4, and the port b of the 1:99 beam splitter 4 is communicated with one end of the isolator 10, and the port c of the 1:99 beam splitter 4 is communicated with port a of the 50:50 beam splitter 3; the other end of the isolator 10 is communicated with the port b of the first 50:50 coupler 5; the port a of the first 50:50 coupler 5 is communicated with one end of detector 2; port c of the first 50:50 coupler 5 is communicated with the first Faraday mirror 8, the port d of the first 50:50 coupler 5 is communicated with the second Faraday mirror 9 via the delay fiber 7; the other end of the detector 2 is communicated with the input end of the lock multiplication circuit module 6, the port b of the 50:50 beam splitter 3 is communicated with the input end of the polarization controller 12 via the reference arm 22; the port c of the 50:50 beam splitter 3 is communicated with port a of the circulator 13 via the test arm 23; the output end of the polarization controller 12 is communicated with port a of the second 50:50 coupler 14; the port b of the circulator 13 is communicated with port b of the second 50:50 coupler 14; port c of the circulator 13 is communicated with the two-dimensional strain sensing fiber 15, and the port c of the second 50:50 coupler 14 is communicated with the input end of first polarization beam splitter 16; port d of the second 50:50 coupler 14 is communicated with the input end of the second polarization beam splitter 17; the output end of the first polarization beam splitter 16 is communicated with the input end of the first balanced detector 18 and the input end of the second balanced detector 19 respectively; the output end of the second polarization beam splitter 17 is communicated with the input end of the first balanced detector 18 and the input end of the second balanced detector 19 respectively; the output end of the first balanced detector 18 is communicated with the input end of the acquisition device 20; the output end of the second balanced detector 19 is communicated with the input end of the acquisition device 20; and the output end of the acquisition device 20 is communicated with the computer 11.

When the two-dimensional strain sensing device operates, the computer 11 controls the tunable laser 1 via the GPIB control module 21 for controlling tuning speed, center wavelength, and start of tuning, etc.; the emergent light of the tunable laser 1 enters port a of the 1:99 beam splitter 4, and the light exits from the port b of the 1:99 beam splitter 4 under the ratio of 1:99 and enters the port b of the first 50:50 coupler 5 via the isolator 10, and then the light exits from the port c and port d of the first 50:50 coupler 5. The two lights are reflected by the first Faraday mirror 8 and the second Faraday mirror 9 which are arranged at the arms of the first 50:50 coupler 5 respectively, and then the lights return back to the port c and port d of the first 50:50 coupler 5, two lights are interfered in the first 50:50 coupler 5 and output from the port a of the first 50:50 coupler 5; the emergent light of the port a of the first 50:50 coupler 5 enters the detector 2, the detector 2 converts the detected optical signal into a beat frequency interference signal and transmits it into the clock shaping circuit module 6 for shaping into square shape, the shaped signal is then transmitted to the acquisition device 20 as the external clock signal.

The emergent light of the tunable laser 1 enters port a of the 1:99 beam splitter 4, and the light emits from the port c of the 1:99 beam splitter 4 and enters the port a of the first 50:50 beam splitter 3, one light beam exits from the port b of the first 50:50 beam splitter 3 and enters the polarization controller 12 on the reference arm 22, the other light beam exits from the port c of the first 50:50 beam splitter 3 and enters port a of the circulator 13 located on the test arm 23, and then light enters the two-dimensional strain sensing fiber 15 via the port c of the circulator 13; and the backscattering light of the two-dimensional strain sensing fiber 15 returns into the port c of the circulator 13 and exits from port b of the circulator 13; the reference light emitted from the polarization controller 12 on the reference arm 22 and the backscattering light emitted from the circulator 13 perform beam combination at port b of the second 50:50 coupler 14 and form a beat frequency interference signal, the signal is then transmitted to the first polarization beam splitter 16 via the port c of the second 50:50 coupler 14 and to the second polarization beam splitter 17 via the port d of the second 50:50 coupler 14; the first polarization beam splitter 16 and the second polarization beam splitter 17 correspondingly collect the signal beams in orthogonal directions, which are emitted from the two polarization beam splitters, via the first balanced detector 18 and the second balanced detector 19, and the first balanced detector 18 and the second balanced detector 19 transmit the output analog signals to the acquisition device 20, and the acquisition device 20 transmits the collected analog signals to the computer 11 by applying the external clock signal formed by the clock shaping circuit module 6.

The computer 11 may control the tunable laser 1 via the GPIB control module 21.

The tunable laser 1 provides light source for OFDR, and the optical frequency of which can perform linear scanning.

The isolator 10 prevents the reflected light emitted from port b of the first 50:50 coupler 5 of the auxiliary interferometer from entering the laser.

The first 50:50 coupler 5 is used for optical interference.

The delay fiber 7 realizes non-equal-arm beat frequency interference, and can achieve the optical frequency based on beat frequency and length of the delay fiber.

The first Faraday mirror 8 and second Faraday mirror 9 provide reflection for the interferometer and eliminate polarization-induced fading of the interferometer.

The polarization controller 12 is used for adjusting polarization of reference light so as to keep light intensity in two orthogonal directions substantially consistent with each other when polarization splitting.

The second 50:50 coupler 14 performs polarization splitting to the signal and eliminates the effect from polarization-induced fading noise.

The computer 11 performs data processing on the interference signal collected by the acquisition device 20, thus achieves distributed temperature and strain sensing based on fiber Rayleigh backscattering shifting.

Wherein, as shown in FIG. 4, the two-dimensional strain sensing fiber 15 of the embodiment of the present invention comprises a fiber 151 and a plane to be measured 152.

The type of the fiber 151 is not limited in this embodiment, and the plane to be measured 152 may be any plane to be measured, the structure thereof is not limited in this embodiment.

The two-dimensional strain sensing device of this embodiment shown in FIGS. 3 and 4 is merely illustrative but not limiting. Other types of two-dimensional strain sensing devices can be used in practical use, and the structure thereof is not limited in the embodiment of the present invention.

Unless otherwise stated, the types of the devices mentioned in the embodiment are not limited, as long as the devices are capable of realizing the above functions.

### Embodiment 4

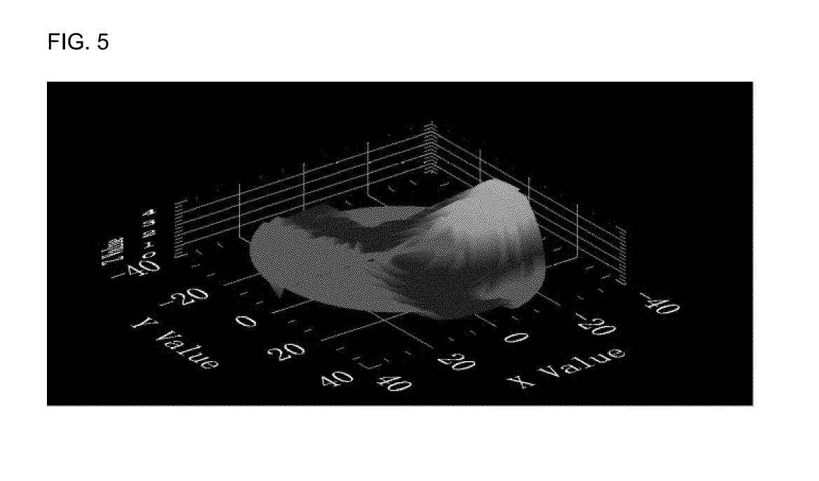

The feasibility of the technical schemes of the embodiment 1 and embodiment 2 will be verified below with reference to FIG. 4 and FIG. 5. The details are as follows:

The verification experiment of the present invention adopts same fiber 151, and demodulates to achieve a two-dimensional strain variation [symbol] according to the two-dimensional strain sensing device and the method thereof of the present invention.

As shown in FIG. 4, a fiber 151 is wound based on Archimedes spiral and attached on the plane to be measured 152, and the plane to be measured 152 is pressed by weight.

The actual strain variation on the plane to be measured 152 can be achieved by applying weight thereon. The effectiveness of the present invention will be verified via comparing the results between the actual strain variation and the strain variation Δε demodulated according to the two-dimensional strain sensing device and the method thereof of the present invention.

As shown in FIG. 5, the display area shows the detectable area of the system, and X-axis and Y-axis correspond to the position coordinates; the position of the compressed point generates strain and is captured by the FIG. 5. It can be seen from FIG. 5 that the Z-axis value of the pressed point is increased and the Z-axis value of the peripheral position is decreased, indicating that the adjacent area of the compressed point is subjected to a reverse strain due to compression acting on the plane to be measured 152.

In conclusion, the embodiment of the present invention performs distributed strain measurement by single-mode fiber Rayleigh backscattering frequency shifting in OFDR, applies Archimedes spiral on the plane to be measured for fiber laying, and measures the two-dimensional strain so as to satisfy the requirement of multi-directional two-dimensional strain sensing.

It will be understood by those skilled in the art that the drawings are merely illustrative of a preferred embodiment, and that the serial No. of the embodiments of the present invention are for illustrative purpose only and are not indicative of ranking.

The foregoing specific implementations are merely illustrative but not limiting. A person of ordinary skill in the art may make any modifications, equivalent replacements and improvements under the teaching of the present invention without departing from the purpose of the present invention and the protection scope of the appended claims, and all the modifications, equivalent replacements and improvements shall fall into the protection scope of the present invention.

What is claimed is:

1. An optical fiber laying method by using Archimedes spiral in optical frequency domain reflection, wherein the optical fiber laying method comprises the following steps:
performing two measurements continuously via a two-dimensional strain sensing device, and performing cross-correlation operation on the two one-dimensional information in the local distance domain, and obtaining the strain variation of the one-dimensional information corresponding to the two measurements from the obtained cross-correlation information;
deriving the two-dimensional angle information and curvature radius information of a plane to be measured corresponding to the one-dimensional information in the local distance domain based on the Archimedes spiral formula;
deriving the position coordinates corresponding to the two-dimensional plane based on the curvature radius information and two-dimensional angle information; and
corresponding the strain variation of the one-dimensional information to the position coordinates corresponding to the two-dimensional plane to obtain the two-dimensional strain information.

2. The optical fiber laying method by using Archimedes spiral in optical frequency domain reflection according to claim 1, wherein the steps of acquiring one-dimensional information in the local distance domain are as follows:
forming a beat frequency interference signal in the two-dimensional strain sensing device by Rayleigh backscattering, and performing fast Fourier transform on the beat frequency interference signal respectively; and
transforming the optical frequency information to the distance domain information corresponding to the respective positions, and selecting the respective positions of the distance domain information through a moving window with certain width successively to obtain the one-dimensional information in the local distance domain.

3. The optical fiber laying method by using Archimedes spiral in optical frequency domain reflection according to claim 1 or claim 2, wherein the optical fiber laying method adopts Archimedes spiral in OFDR, which uses a fiber to measure the strain of the two-dimensional space.

4. The optical fiber laying method by using Archimedes spiral in optical frequency domain reflection according to claim 1 or claim 2, wherein the end of the fiber does not require any additional apparatus.

5. The optical fiber laying method by using Archimedes spiral in optical frequency domain reflection according to claim 1 or claim 2, wherein the formulae of the step of “corresponding the strain variation of the one-dimensional information to the position coordinates corresponding to the two-dimensional plane to obtain the two-dimensional strain information” are:
$$x = a * cos ( \sqrt{\frac{2 L}{a}} )$$
$$y = a * sin ( \sqrt{\frac{2 L}{a}} )$$
Wherein, the parameter a>0, and L is curve length.
